(19) United States
(12) Patent Application Publication
(10) Pub. No.: US 2001/0015601 A1
(43) Pub. Date: Aug. 23, 2001

(54) Fixing sleeve for a spark plug

(76) Inventor: Werner Henkel, Kramsach (AT)

Correspondence Address: LORUSSO & LOUD, 440 Commercial Street, Boston, MA, 02109, US

(21) Appl. No.: 09/790,736

(22) Filed: Feb. 22, 2001

(30) Foreign Application Priority Data
Feb. 22, 2000 (AT) A 265/2000

(51) Int. Cl. H01T 13/00; H01T 13/20

(52) U.S. Cl. 313/11.5; 313/143; 313/118

(57) ABSTRACT

A fixing sleeve (2) for a spark plug (1) comprising coolant passages (3) which are arranged in the wall of the fixing sleeve (2) and which are oriented substantially in the longitudinal direction of the spark plug, wherein the fixing sleeve (2) comprises a metallic material whose thermal conductivity is over 60 W/m° C., preferably over 80 W/m° C.

### DESCRIPTION

The present invention concerns a fixing sleeve for a spark plug comprising coolant passages which are arranged in the wall of the fixing sleeve and which are oriented substantially in the longitudinal direction of the spark plug.

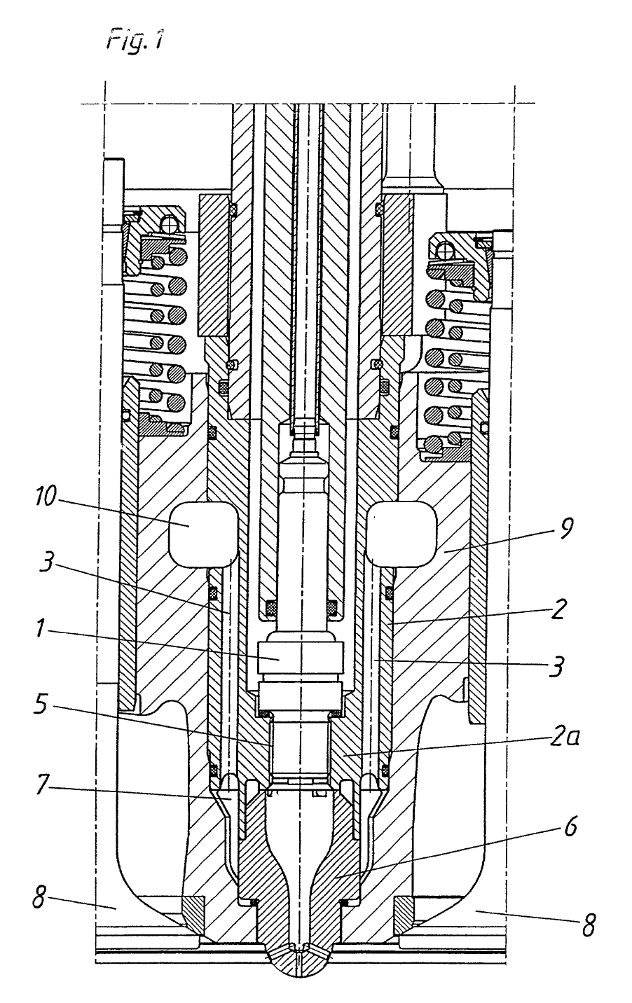

The function of a fixing sleeve of the kind is to anchor a spark plug securely and firmly in the cylinder head. For that purpose in the front region the fixing sleeve has an enlargement which faces in the direction of the through passage of the fixing sleeve and in which a screwthread is provided. The spark plug is screwed into that screwthread. Besides the function of securely and firmly anchoring the spark plug the fixing sleeve must also carry away the heat which is produced when ignition occurs. For that purpose, in the state of the art (FIG. 1) the wall of the fixing sleeve has usually been provided with coolant passages which extend straight. It was possible for those straight coolant passages to be easily produced by means of drilling. Practical experience has shown however that the hitherto usual design configuration of the fixing sleeve admittedly ensures a good anchorage, but in regard to the cooling effect which is increasingly required, by virtue of the continuing rise in output of engines, it scarcely attains the values required. Inadequate cooling however results in faster wear of the spark plug.

U.S. Pat. No. 3,765,384 shows an embodiment of fixing sleeve in which, in the region of the screwthread into which the spark plug is screwed, the coolant passages are widened towards the screwthread. That configuration thus takes the coolant closer to the spark plug, for the purposes of better cooling.

Now, the object of the present invention is to provide a fixing sleeve which ensures a longer service life for the spark plugs, by virtue of a further improvement in the dissipation of heat.

In accordance with the invention, that is achieved in that the fixing sleeve comprises a metallic material whose thermal conductivity is over 60 W/m° C., preferably over 80 W/m° C.

Hitherto the material used for the fixing sleeve was high-alloyed steel as optimum anchoring of the spark plug was the factor to which primary attention was paid. The use of a metallic material with a level of thermal conductivity which is markedly improved in comparison with steel admittedly involves a reduction in strength properties. Extensive studies have shown however that it is possible to arrive at a compromise in which the cooling aspect is taken into account to a greater degree.

Particularly suitable materials are brass or nickel and alloys formed therewith.

The continuing rises in engine output levels also result in an increasing level of stress on an antechamber mounted to the fixing sleeve. It is therefore desirable for that antechamber to be made from a nickel-chromium alloy with over 25% chromium, preferably about 30% chromium.

For cooling the antechamber, it is desirable if the antechamber is surrounded by an annular passage into which the coolant passages open.

A preferred embodiment provides that the coolant passages are brought closer to the spark plug in the front region of the fixing sleeve, which preferably has a screwthread for screwing in the spark plug. The coolant passages are thus moved closer to the location at which the greatest generation of heat occurs and can accordingly more efficiently carry the heat away.

An alternative configuration that the coolant passages have enlargements which face towards the spark plug in the front region of the fixing sleeve. Practical tests have shown that, in spite of the weakening of the front region of the fixing sleeve by virtue of the presence of the enlargements, there is still sufficient stability for securely anchoring the spark plug.

The weakening in the front region can be avoided by the configuration of the coolant passages in the front region of the fixing sleeve being adapted to the contour of the spark plug. It will be appreciated however that adaptation to the contour of the spark plug increases the manufacturing cost for producing the coolant passages.

Optimum cooling results are achieved if the remaining wall thickness in the front region of the fixing sleeve between the spark plug and coolant passages is partly below 5 mm, preferably being about between 2 and 3 mm.

Further features and details of the present invention will be apparent from the specific description hereinafter. In the drawing:

FIG. 1 shows a fixing sleeve in accordance with the state of the art,

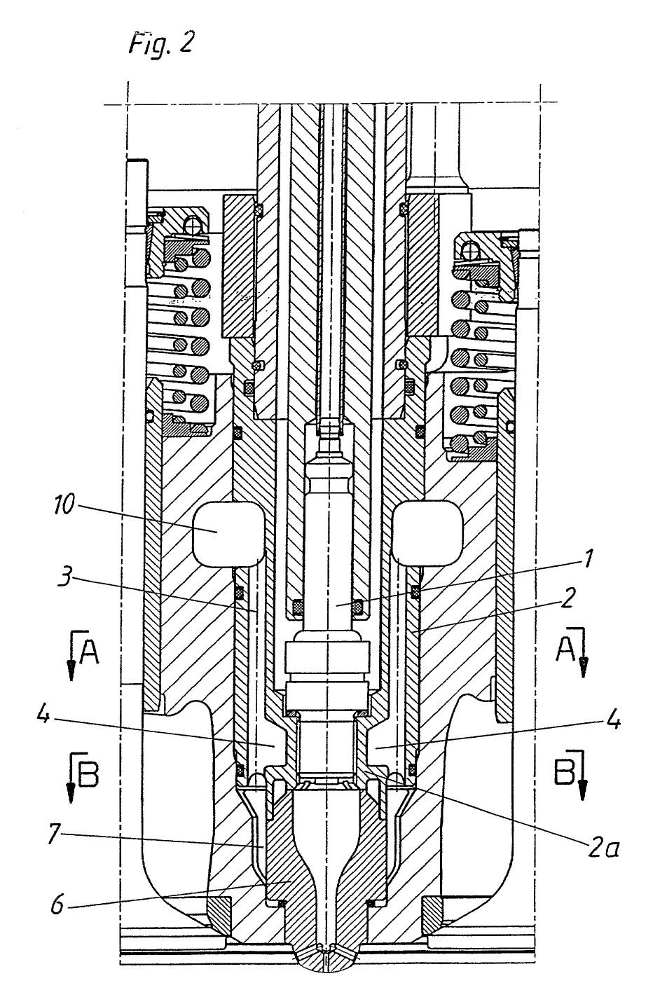

FIG. 2 is a view in longitudinal section of a first alternative embodiment of a fixing sleeve according to the invention,

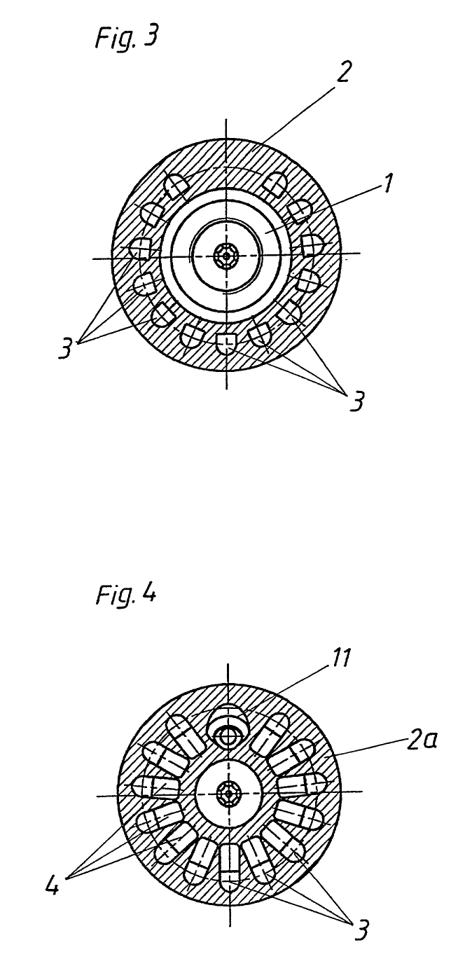

FIG. 3 is a view in cross-section taken along line A-A in FIG. 2,

FIG. 4 is a view in cross-section taken along line B-B in FIG. 2,

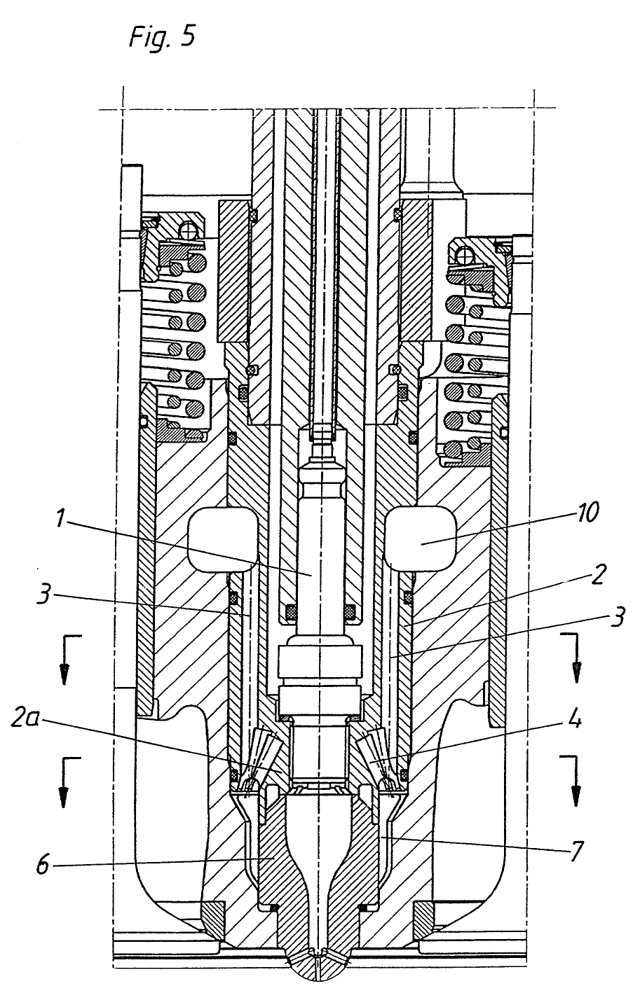

FIG. 5 is a view in longitudinal section of a second alternative embodiment of a fixing sleeve according to the invention,

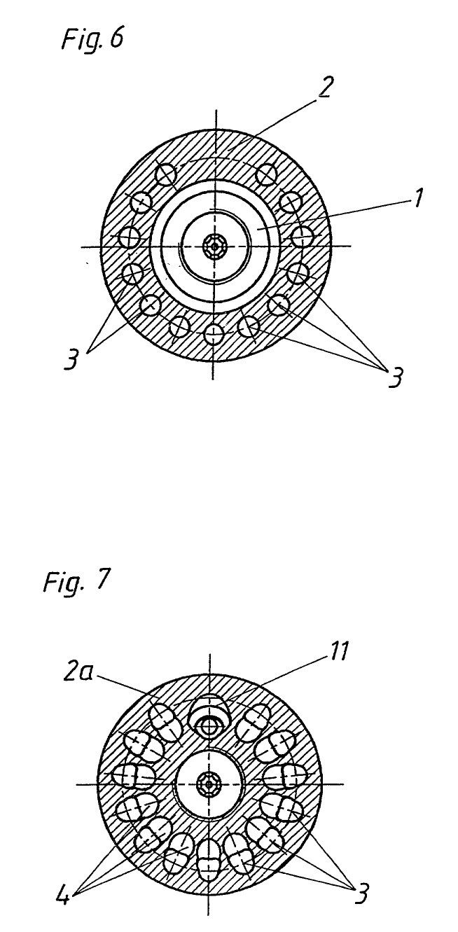

FIG. 6 is a view in cross-section taken along line C-C in FIG. 5, and

FIG. 7 is a view in cross-section taken along line D-D in FIG. 5.

As the Figures show the fixing sleeve 2 serves to anchor a spark plug 1 in the cylinder head 9. In this case the fixing sleeve 2 is disposed between the inlet and exhaust valves 8.

The fixing sleeve 2 is reinforced in its front region 2a. Provided in that region 2a is a screwthread 5 into which the spark plug 1 is screwed.

The fixing sleeve 2 is provided with coolant passages 3 for cooling the spark plug 1. The coolant passages 3 extend through the wall of the fixing sleeve 2. In the state of the art as shown in FIG. 1 those coolant passages 3 are in the form of straight cylindrical bores. They lead from a manifold 10 straight to the annular passage 7 which surrounds the antechamber 6 arranged in front of the spark plug 1 on the fixing sleeve 2.

In contrast thereto, in the embodiment illustrated in FIG. 2, the coolant passages 3 are provided with enlargements 4 in the front region 2a of the fixing sleeve 2. The coolant therefore goes closer to the location at which the greatest amount of heat is generated in the front region of the spark plug 1.

The fixing sleeve 2 can be made from brass, a brass alloy, nickel, a nickel alloy or also another metallic material if its thermal conductivity is over 60 W/m° C., preferably over 80 W/m° C. At the same time it must enjoy sufficient strength for securely anchoring the spark plug 1. The thermal conductivity of brass and nickel is approximately three times as high as the high-alloyed steel which has been used hitherto, whereas the strength values are only slightly worse. Better machinability is a further factor in favour of brass and nickel.

It will be apparent from FIGS. 3 and 4 that disposed in the wall of the fixing sleeve 2 is a plurality of coolant passages 3 which surround the spark plug 1. The only exception is that region in which the gas injection conduit 11 and the gas injection valve are arranged. The antechamber 6 is supplied with ignition fluid by way of the gas injection conduit 11 and the gas injection valve.

The antechamber 6 which can be brazed to the fixing sleeve 2 (FIG. 2) or screwed thereto (FIG. 5) comprises a nickel-chromium alloy with about a 30% proportion of chromium. That alloy makes the antechamber 6 particularly heat-resistant.

Besides the different connection between the antechamber and the fixing sleeve FIG. 5 differs from FIG. 2 in that the enlargements 4 are in the form of additional bores. Those additional bores are particularly easy to implement from the production process point of view. Once again the remaining wall thickness is greatly reduced. The enlargements 4 approach the spark plug 1 to a spacing of between about 2 and 3 mm.

1. A fixing sleeve for a spark plug comprising coolant passages which are arranged in the wall of the fixing sleeve and which are oriented substantially in the longitudinal direction of the spark plug, characterised in that the fixing sleeve comprises a metallic material whose thermal conductivity is over 60 W/m° C.

2. The fixing sleeve according to claim 1, characterised in that the fixing sleeve comprises a metallic material whose thermal conductivity is over 80 W/m° C.

3. The fixing sleeve according to claim 1 characterised in that the fixing sleeve comprises brass or a brass alloy.

4. The fixing sleeve according to claim 1 characterised in that the fixing sleeve comprises nickel or a nickel alloy.

5. The fixing sleeve according to claim 1 characterised in that mounted to the fixing sleeve is an antechamber which comprises a nickel-chromium alloy with over 25% chromium.

6. The fixing sleeve according to claim 5 wherein said nickel-chromium alloy comprises about 30% chromium.

7. The fixing sleeve according to claim 5 characterised in that the antechamber is surrounded by an annular passage into which the coolant passages open.

8. The fixing sleeve according to claim 1 characterised in that the coolant passages are brought closer to the spark plug in the front region of the fixing sleeve, which region has a screwthread for screwing in the spark plug.

9. The fixing sleeve according to claim 8 characterised in that in the front region of the fixing sleeve the coolant passages have enlargements facing towards the spark plug.

10. The fixing sleeve according to claim 8 characterised in that the configuration of the coolant passages is adapted to the contour of the spark plug in the front region of the fixing sleeve.

11. The fixing sleeve according to claim 8 characterised in that the remaining wall thickness in the front region of the fixing sleeve between the spark plug and coolant passages is partially below 5 mm.

12. The fixing sleeve according to claim 1 characterised in that a plurality of coolant passages is arranged around the spark plug.

13. A cylinder head characterised in that at least one fixing sleeve according to claim 1 is arranged therein.
